(19) United States
(12) Patent Application Publication
(10) Pub. No.: US 2017/0316017 A1
(43) Pub. Date: Nov. 2, 2017

(54) MULTI HARD-DISK FILE MANAGEMENT SYSTEM AND METHOD THEREOF

(71) Applicant: inXtron, Inc., New Taipei City (TW)

(72) Inventor: Szu-Tien CHEN, New Taipei City (TW)

(73) Assignee: inXtron. Inc.

(21) Appl. No.: 15/186,698

(22) Filed: Jun. 20, 2016

(30) Foreign Application Priority Data
Apr. 28, 2016 (TW) TW105113341

(51) Int. Cl. G06F 17/30

(52) U.S. Cl. CPC G06F 17/30091; G06F 17/302

(57) ABSTRACT

The instant disclosure provides a multi hard-disk file management system and a method thereof. The multi hard-disk file management system comprises at least one external hard disk, a host computer and a file database. The external hard disk has an identifier and a file contents directory. The host computer runs a multi hard-disk file management program to manage the external hard disks. The file database is built in the host computer or a cloud computer. When the external hard disk is connected to the host computer, the identifier and the file contents directory corresponding to the external hard disk are stored in the file database by operating the multi hard-disk file management program.

### BACKGROUND OF THE INVENTION

### 1. Technical Field

The instant disclosure relates to a file management system and method thereof; more particular, to a multi hard-disk file management system and method thereof that help a user to search for a target data more conveniently.

### 2. Description of Related Art

With the development in the field of computer technology, a computer product is required to have a greater storage capability, and thus a user may need plenty of external hard disks for one computer to save data. Especially for a server system or a memory system, there may be several or even tens of SAS hard disks or SATA hard disks equipped. For a computer equipped with lots of hard disks, the operating system run by the computer can identify them through a driver and will label each of them by an identifier. For example, under the Windows operating system, they are labeled as “C:”, “D:”, “E:” and the like. However, a user cannot tell which physical hard disk is referred by “C:”, “D:” or “E:”. Moreover, without an efficient system and method thereof to manage data stored in these hard disks, if the user wants to find certain data, he always needs to search for it through each hard disk, and it is time-consuming.

### BRIEF SUMMARY OF THE INVENTION

The instant disclosure provides a multi hard-disk file management system and method thereof. Data stored in a plurality of hard disks can be efficiently managed by using this management system and method thereof.

The multi hard-disk file management system provided by the instant disclosure comprises at least one external hard disk, a host computer and a file database. The external hard disk has an identifier and a file contents directory. The host computer runs a multi hard-disk file management program to manage the external hard disk. The file database is built in the host computer or a cloud computer. When the external hard disk is connected to the host computer, the identifier and the file contents directory corresponding to the external hard disk can be stored in the file database by operating the multi hard-disk file management program.

In one embodiment of the multi hard-disk file management system provided by the instant disclosure, a look-up table is stored in the file database, and a corresponding relationship between the identifier of the external hard disk and a device location code of the external hard disk is obtained from the look-up table.

In one embodiment of the multi hard-disk file management system provided by the instant disclosure, the identifier of the external hard disk storing a target data is obtained from the file database by operating the multi hard-disk file management program.

In one embodiment of the multi hard-disk file management system provided by the instant disclosure, the device location code of the external hard disk storing the target data is obtained according to the look-up table.

In one embodiment of the multi hard-disk file management system provided by the instant disclosure, the external hard disk has a health status information, and the health status information is stored in the file database by operating the multi hard-disk file management program.

In one embodiment of the multi hard-disk file management system provided by the instant disclosure, the health status information of the external hard disk is obtained from the file database by operating the multi hard-disk file management program.

The instant disclosure further provides a multi hard-disk file management method. The multi hard-disk file management method is used in a multi hard-disk file management system. The multi hard-disk file management system comprises at least one external hard disk, a host computer and a file database. The external hard disk has an identifier and a file contents directory. The host computer runs a multi hard-disk file management program. The file database is built in the host computer or a cloud computer. The multi hard-disk file management method comprises: storing the identifier corresponding to the external hard disk in the file database by operating the multi hard-disk file management program; storing the file contents directory corresponding to the external hard disk in the file database by operating the multi hard-disk file management program; searching for a target data from the file database by operating the multi hard-disk file management program; and obtaining the identifier of the external hard disk storing the target data from the file database by operating the multi hard-disk file management program.

To sum up, by using the multi hard-disk file management system and method thereof provided by the instant disclosure, a plurality of external hard disks can be efficiently managed, and thus a user can search for a target data much easier.

For further understanding of the instant disclosure, reference is made to the following detailed description illustrating the embodiments of the instant disclosure. The description is only for illustrating the instant disclosure, not for limiting the scope of the claim.

### BRIEF DESCRIPTION OF THE SEVERAL VIEWS OF THE DRAWINGS

Embodiments are illustrated by way of example and not by way of limitation in the figures of the accompanying drawings, in which like references indicate similar elements and in which:

FIG. 1 shows a block diagram of a multi hard-disk file management system of one embodiment of the instant disclosure;

FIG. 2 shows a schematic diagram of a multi hard-disk file management system of another embodiment of the instant disclosure; and

FIG. 3 shows a flow chart of a multi hard-disk file management method of one embodiment of the instant disclosure.

### DETAILED DESCRIPTION OF THE EMBODIMENTS OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

There are embodiments provided to illustrate but not to restrict the multi hard-disk file management system and method of the instant disclosure, by which a plurality of hard disks can be efficiently managed and thus a user can search for a target data he wants much easier and more time-saving.

[One Embodiment of the Multi Hard-Disk File Management System]

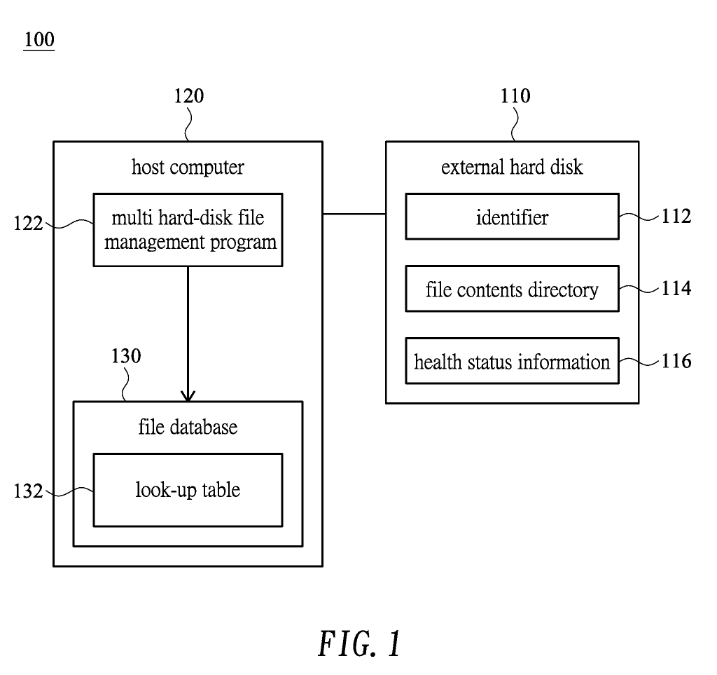

Referring to FIG. 1, FIG. 1 shows a block diagram of a multi hard-disk file management system of one embodiment of the instant disclosure. As shown in FIG. 1, the multi hard-disk file management system 100 comprises at least one external hard disk 110, a host computer 120 and a file database 130. The file database 130 is built in the host computer 120. The external hard disk 110 at least has an identifier 112, a file contents directory 114 and a health status information 116. The host computer 120 works under an operating system (not shown) and runs a multi hard-disk file management program 122. The multi hard-disk file management program 122 is a program that is used for managing one or more than one external hard disks 110.

The following description is for further illustrating the working mechanism of the multi hard-disk file management system 100.

There is at least one embodiment provided in order to illustrate the working mechanism of the multi hard-disk file management system 100 in detail.

With the development in the field of computer technology, a greater storage capability of computer products is required by users, and thus a user may need plenty of external hard disks to save data. However, the user may not able to efficiently manage these external hard disks and may spend lots of time to find the data he wants, if there is no efficient management system and method thereof. Thus, in this embodiment, when the external hard disk 110 is connected to the host computer 120, the host computer 120 can store an identifier 112, a file contents directory 114 and a health status information 116 of the external hard disk 110 in the file database 130 by operating the multi hard-disk file management program 122. The file database 130 stores a look-up table 132, and from the look-up table 132 the multi hard-disk file management program 122 can obtain a corresponding relationship between the identifier 112 of the external hard disk 110 and a device location code of the external hard disk 110. Briefly, the identifier 112, the file contents directory 114 and the health status information 116 of the external hard disk 110 can be systematically stored in the file database 130, and they can be found anytime from the file database 130 by using the look-up table 132 and operating the multi hard-disk file management program 122. In other words, a user needs not to manually connect the external hard disks 110, one by one, to the host computer 120 to know the information of the external hard disks 110, such as the identifier 112, the file contents directory 114 and the health status information 116 of the external hard disk 110. In one embodiment, a user can obtain the file contents directory 114 and the health status information 116 of one external hard disk 110 from the file database 130 by operating the multi hard-disk file management program 122.

For example, when a user wants to find a target data but has no idea that in which external hard disk he can find that data, he can operate the multi hard-disk file management program 122 through the host computer 120 to search for the target data from all file contents directories 114 stored in the file database 130. After that, he can know the file contents directory 114 that the target data is written in, and can further obtain the identifier 112 of the external hard disk 110 that stores the target data. Specifically speaking, the target data is categorized somewhere in the file contents directory 114 of one external hard disk 110, and the file contents directory 114 and the identifier 112 of this external hard disk 110 are corresponding. After that, knowing the identifier 112 of the external hard disk 110 that stores the target data, the user can obtain a device location code of the external hard disk 110 according to the look-up table 132 stored in the file database 130. It is worth mentioning that, the device location code of the external hard disk 110 indicates where the external hard disk 110 storing the target data is. In other words, knowing a location according to the device location code of the external hard disk 110, the user can directly find and grab the external hard disk 110 to further obtain the target data stored therein, instead of looking for the external hard disk 110 by checking each external hard disk in the system. According to the above, by using the multi hard-disk file management system 100, a user can efficiently manage a plurality of external hard disks 110, and it is easier and takes less time for him to find a physical hard disk that stores the data he wants.

In the following embodiments, there are only parts different from the embodiment shown in FIG. 1 described, and the omitted parts are indicated to be identical to the embodiment shown in FIG. 1. In addition, for an easy instruction, similar reference numbers or symbols refer to elements alike.

[Another Embodiment of the Multi Hard-Disk File Management System]

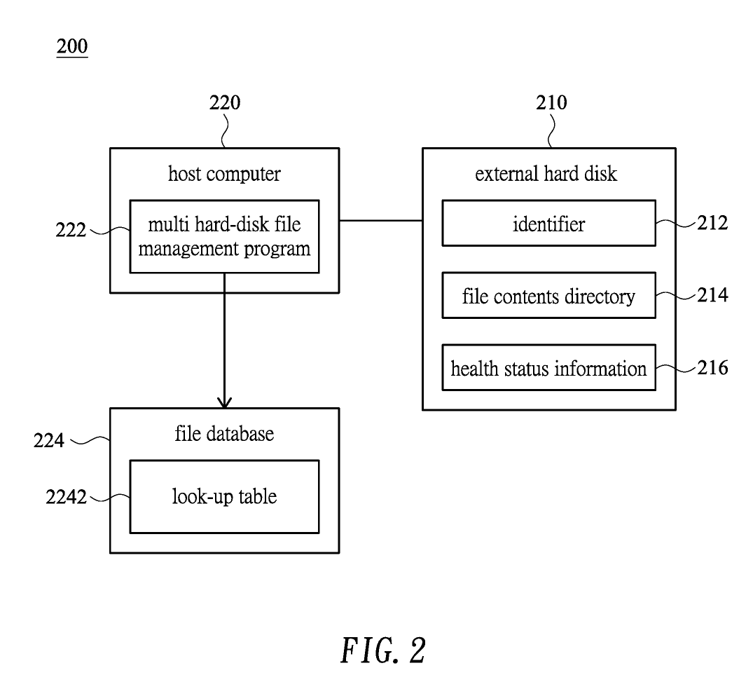

Referring to FIG. 2, FIG. 2 shows a schematic diagram of a multi hard-disk file management system of another embodiment of the instant disclosure. As shown in FIG. 2, the multi hard-disk file management system 200 comprises at least one external hard disk 210 and a host computer 220. A file database 224 is connected to the host computer 220. The external hard disk 210 at least has an identifier 212, a file contents directory 214 and a health status information 216. Likewise, the host computer 220 works under an operating system (not shown) and runs a multi hard-disk file management program 222, and a look-up table 2242 is stored in the file database 224.

Commonly, users use their storage devices to save data. If one storage device does not have enough memory to save all data, more storage devices can be added to provide larger memory. The storage device may be a hard disk or the like, such as the Network Attached Storage (NAS) technology which uses lots of hard disks to have more memory. In one embodiment, the file database 224 is built in a cloud computer that runs a multi hard-disk file management program. In this manner, a user can use a terminal device or a mobile device, which is connected to the cloud computer via the Internet, to manage data stored in hard disks by operating the multi hard-disk file management program.

[One Embodiment of the Multi Hard-Disk File Management Method]

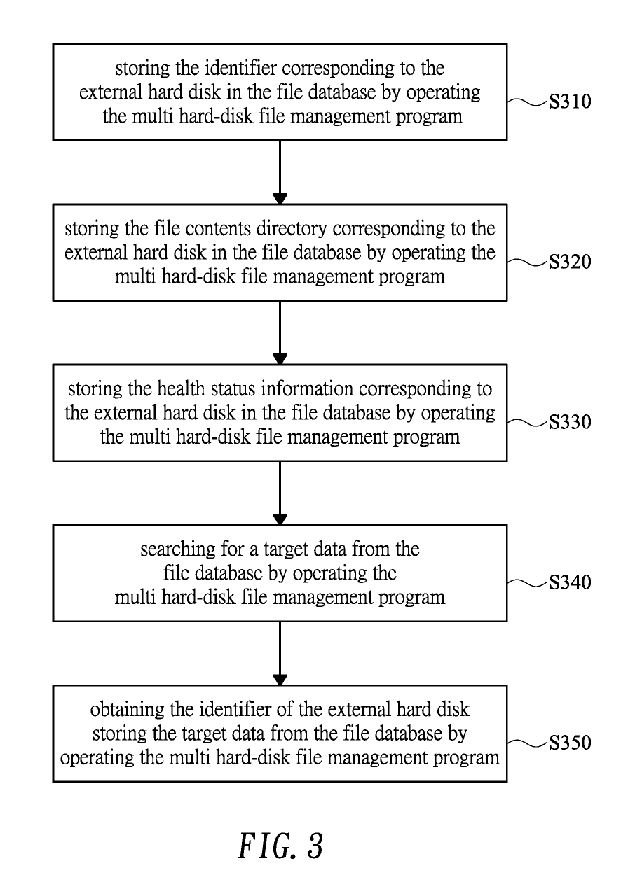

Referring to FIG. 3, FIG. 3 shows a flow chart of the multi hard-disk file management method of one embodiment of the instant disclosure. Explanatory steps of the present embodiment may be embodied with the multi hard-disk file management system shown in FIG. 1 or FIG. 2, and thus FIG. 1 and FIG. 2 are also referred for an easy instruction and better understanding.

The multi hard-disk file management method comprises steps as follows. In step S310, the identifier corresponding to the external hard disk is stored in the file database by operating the multi hard-disk file management program. In step S320, the file contents directory corresponding to the external hard disk is stored in the file database by operating the multi hard-disk file management program. Moreover, in step S330, the health status information corresponding to the external hard disk is stored in the file database by operating the multi hard-disk file management program. After that, step S340 is to search for a target data from the file database by operating the multi hard-disk file management program. Finally, in step S350, the identifier of the external hard disk storing the target data is obtained from the file database by operating the multi hard-disk file management program. In one embodiment, the multi hard-disk file management method further comprises a step of obtaining a corresponding relationship between the identifier of the external hard disk and a device location code of the external hard disk from a look-up table, and a step of obtaining the device location code of the external hard disk storing the target data according to the look-up table. The working details of each step of the multi hard-disk file management method are clearly illustrated in the embodiments shown in FIG. 1 and FIG. 2, and thus the redundant information is not repeated.

It is clarified that, a sequence of steps in FIG. 3 is set for a need to instruct easily, and thus the sequence of the steps is not used as a condition in demonstrating the embodiments of the instant disclosure.

To sum up, by using the multi hard-disk file management system and method thereof provided by the instant disclosure, a plurality of external hard disks can be efficiently managed by a user, and thus when the user needs to search for a target data, it will be much easier and time-saving.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A multi hard-disk file management system, comprising:
at least one external hard disk having an identifier and a file contents directory;
a host computer running a multi hard-disk file management program to manage the external hard disk; and
a file database built in the host computer or a cloud computer, wherein when the external hard disk is connected to the host computer, the identifier and the file contents directory corresponding to the external hard disk are stored in the file database by operating the multi hard-disk file management program.

2. The multi hard-disk file management system according to claim 1, wherein a look-up table is stored in the file database, and a corresponding relationship between the identifier of the external hard disk and a device location code of the external hard disk is obtained from the look-up table.

3. The multi hard-disk file management system according to claim 2, wherein the identifier of the external hard disk storing a target data is obtained from the file database by operating the multi hard-disk file management program.

4. The multi hard-disk file management system according to claim 3, wherein the device location code of the external hard disk storing the target data is obtained according to the look-up table.

5. The multi hard-disk file management system according to claim 1, wherein the external hard disk has a health status information, and the health status information is stored in the file database by operating the multi hard-disk file management program.

6. The multi hard-disk file management system according to claim 5, wherein the health status information of the external hard disk is obtained from the file database by operating the multi hard-disk file management program.

7. A multi hard-disk file management method, used in a multi hard-disk file management system, the multi hard-disk file management system comprising at least one external hard disk, a host computer and a file database, wherein the external hard disk has an identifier and a file contents directory, the host computer runs a multi hard-disk file management program and the file database is built in the host computer or a cloud computer, the multi hard-disk file management method comprising:
storing the identifier corresponding to the external hard disk in the file database by operating the multi hard-disk file management program;
storing the file contents directory corresponding to the external hard disk in the file database by operating the multi hard-disk file management program;
searching for a target data from the file database by operating the multi hard-disk file management program; and
obtaining the identifier of the external hard disk storing the target data from the file database by operating the multi hard-disk file management program.

8. The multi hard-disk file management method according to claim 7, further comprising:
obtaining a corresponding relationship between the identifier of the external hard disk and a device location code of the external hard disk from a look-up table.

9. The multi hard-disk file management method according to claim 8, wherein the look-up table is stored in the file database.

10. The multi hard-disk file management method according to claim 8, further comprising:
obtaining the device location code of the external hard disk storing the target data according to the look-up table.

11. The multi hard-disk file management method according to claim 7, wherein the external hard disk has a health status information.

12. The multi hard-disk file management method according to claim 11, further comprising:
storing the health status information corresponding to the external hard disk in the file database by operating the multi hard-disk file management program.
